(19) United States
(12) Patent Application Publication
(10) Pub. No.: US 2006/0215907 A1
(43) Pub. Date: Sep. 28, 2006

(54) Method of color compression

(76) Inventor: Mordechai Shefer, Haifa (IL)

Correspondence Address: Mark Friedman;Bill Polkinghorn, 9003 Florin Way, Upper Marlboro, MD, 20772, US

(21) Appl. No.: 10/557,807

(22) PCT Filed: May 27, 2004
(86) PCT No.: PCT/IL04/00458

§ 371 Date: Nov. 23, 2005

Related U.S. Application Data
(60) Provisional application No. 60/473,132, filed on May 27, 2003.

(51) Int. Cl. G06K 9/00; G06K 9/36

(52) U.S. Cl. 382/166; 382/232

(57) ABSTRACT

A color is encoded by defining the color as a triplet of Cartesian color space (e.g., RGB) (FIG. 1) coordinate values and transforming the triplet to spherical coordinates (FIG. 1) to give a transformed triplet of spherical coordinate values (FIG. 1). An image that includes a plurality of image pixels with Cartesian color space coordinate values is compressed by transforming to spherical coordinates, spatially downsampling with respect to one or more of the spherical coordinates and truncating the wordlengths of all the values of one or more of the spherical coordinates. A color image compression device includes a processor for so transforming and downsampling input image pixels.

### FIELD AND BACKGROUND OF THE INVENTION

The present invention relates to the digital representation of color and, more particularly, to a method of compressing color images.

A digital color image is an array of pixels. With each pixel is associated a numerical representation of that pixel's color in a color space. For example, the most common color space for displaying color images on a video monitor is the RGB (Red, Blue, Green) color space. This color space has three coordinates, R, G and B. The color of a pixel is represented as a triplet of three numbers: the value of the R coordinate, the value of the G coordinate and the value of the B coordinate. Typically, each of the three coordinate values is represented as an eight-bit word, for a total of 24 bits per pixel. This allows the display of 256³=16,777,216 distinct colors, commonly referred to as “True Color”.

To reduce the digital volume needed to store or transmit an RGB image, the image is compressed. The conventional compression method is to transform the RGB coordinates to a different color space, the Luminance/Chrominance (YUV) color space, and to spatially downsample the resulting transformed value to give a spatially resampled image that emphasizes the Y coordinate (brightness or luminance) at the expense of the U and V coordinates (chrominance coordinates), to take advantage of the fact that the human eye is more sensitive to spatial changes in brightness than to changes in color. Typically, the spatial downsampling is effected by merging pairs of pixels with respect to the chrominance coordinates. FIG. 4 illustrates one way of doing this spatial downsampling: “4:2:2 downsampling”. At the top of FIG. 4 are four adjacent image pixels 20, 22, 24 and 26, each with its respective values of the R, G and B coordinates. The transformation to YUV coordinates gives, for each image pixel, respective values of the Y, U and V coordinates. Then, pixels 20 and 22 are merged with respect to their chrominance coordinates into a single downsampled pixel 28, and pixels 24 and 26 are merged with respect to their chrominance coordinates to give a single downsampled pixel 30. In this specific example, this is done by dropping the chrominance coordinate values of image pixels 22 and 26 in favor of the chrominance coordinate values of image pixels 20 and 24; but it also could be done by averaging the chrominance coordinates of image pixels 20 and 22 and by averaging the chrominance coordinates of image pixels 24 and 26. The net result is to replace, for each group of four image pixels, 96 bits with 64 bits, i.e., 16 bits per image pixel. Unfortunately, this spatial downsampling also visibly degrades the quality of the resulting image.

There is thus a widely recognized need for, and it would be highly advantageous to have, a method of downsampling a digital image, e.g. from 24 bits per pixel to 8 bits per pixel, with no appreciable loss in image quality.

### SUMMARY OF THE INVENTION

According to the present invention there is provided a method of encoding a color, including the steps of: (a) defining the color as a triplet of Cartesian color space coordinate values; and (b) transforming the triplet to spherical coordinates.

According to the present invention there is provided a method of compressing an image that includes a plurality of image pixels, each image pixel including a respective triplet, of Cartesian color space coordinate values, all the coordinate values having a common color space coordinate wordlength, the method including the steps of: (a) transforming the each triplet to spherical coordinates, thereby providing a respective transformed triplet of spherical coordinate values; and (b) spatially downsampling the image pixels with respect to at least one of the spherical coordinates; thereby producing, for each at least one spherical coordinate, a plurality of downsampled pixels.

According to the present invention there is provided a color image compression device, for compressing an image that includes a plurality of image pixels, each image pixel including a respective triplet, of Cartesian color space coordinate values, that has a color space coordinate wordlength, the device including: (a) a processor for: (i) transforming each triplet to spherical coordinates, thereby providing a respective transformed triplet of spherical coordinate values, and spatially downsampling the image pixels with respect to at least one of the spherical coordinates, thereby producing, for each at least one spherical coordinate, a plurality of downsampled pixels.

One aspect of the present invention is a method of encoding a color by defining the color as a triplet of Cartesian color space coordinate values and transforming the triplet to spherical coordinates, thereby producing a transformed triplet of spherical coordinate values. Preferably, the color space is an RGB color space and the azimuth coordinate of the spherical coordinates is in either the RG plane of the RGB space or in the RB plane of the RGB space or in the GB plane of the RGB space.

Preferably, the triplet, as initially defined, has a certain color space coordinate wordlength, and the method also includes the step of truncating the wordlength of at least one of the spherical coordinate values to a lower wordlength than the original color space wordlength.

Another aspect of the present invention is a method of compressing an image. The image includes a plurality of image pixels. Each image pixel includes a respective triplet of Cartesian color space coordinate values, all of which have a common color space coordinate wordlength. As in the first aspect of the present invention, each triplet is transformed to spherical coordinates, thereby producing, for each triplet, a transformed triplet of spherical coordinate values. Then the image pixels are spatially downsampled with respect to one or more of the spherical coordinates, thereby producing a plurality of downsampled pixels for the targeted spherical coordinate(s).

Preferably, the downsampling is done with respect to the angular spherical coordinates, i.e., the azimuth coordinate and the elevation coordinate.

Preferably, the wordlengths of the coordinate values of one or more of the spherical coordinates are truncated to a lower wordlength than the color space coordinate wordlength. Preferably, the combination of downsampling and truncation produces an average number of bits per image pixel that is less than twice the color space coordinate wordlength. Most preferably, the combination of downsampling and truncation produces an average number of bits per image pixel that is at most the color space coordinate wordlength.

A color image compression device of the present invention includes a processor for implementing the second aspect of the present invention. Preferably, the device also includes a medium for storing the downsampled pixels and/or a transmitter for transmitting the downsampled pixels.

### BRIEF DESCRIPTION OF THE DRAWINGS

The invention is herein described, by way of example only, with reference to the accompanying drawings, wherein:

FIG. 1 illustrates the transformation of RGB coordinates to Yαβ coordinates according to the present invention;

FIGS. 2 and 3 are high-level block diagrams of image compression devices of the present invention;

FIG. 4 illustrates 4:2:2 spatial downsampling in the context of the prior art;

FIG. 5 illustrates 4:1:1 spatial downsampling in the context of the present invention.

### DESCRIPTION OF THE PREFERRED EMBODIMENTS

The present invention is of a method of compressing digital images. Specifically, the present invention can be used to compress an RGB image 3:1 with no appreciable loss in image quality.

The principles and operation of image compression according to the present invention may be better understood with reference to the drawings and the accompanying description.

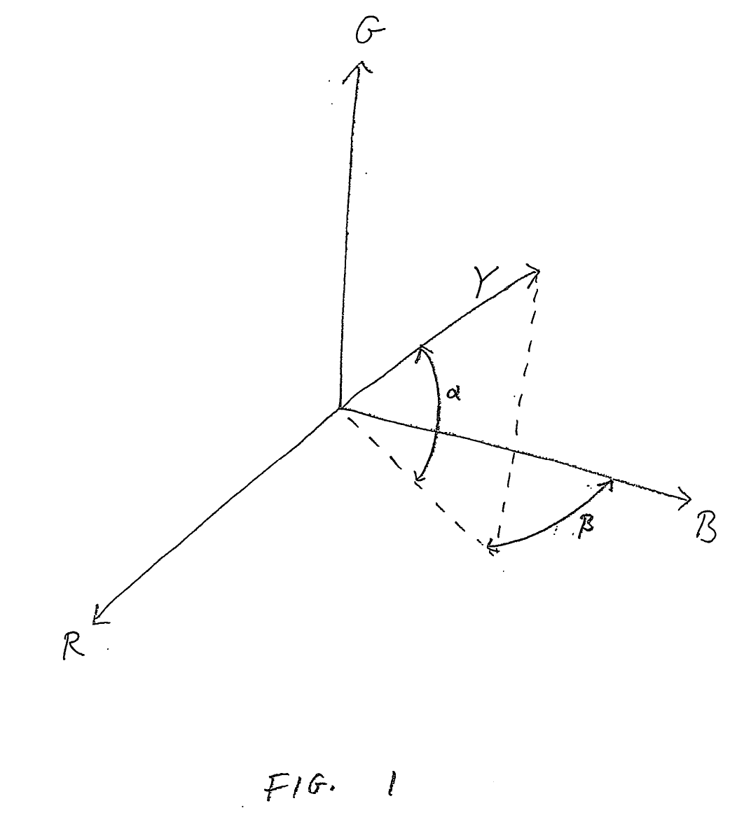

Referring now to the drawings, FIG. 1 illustrates the Yap coordinate system of the present invention. Yαβ is a new color space that bears the same relationship to the RGB color space as spherical coordinates bear to Cartesian coordinates. Y is the radial coordinate (Y=\sqrt{R²+G²+B²}), α is the elevation coordinate and β is the azimuth coordinate. As defined in FIG. 1, β is in the RB plane. In alternate embodiments of the present invention, β is in the RG plane or in the GB plane. Y is luminance, as in the YUV color space; but the new color coordinates α and β do not bear a direct relationship to the U and V coordinates of the YUV color space. Given a triplet of RGB coordinate values, the corresponding values of the Y, α and β coordinates together constitute a transformed triplet of spherical coordinate values.

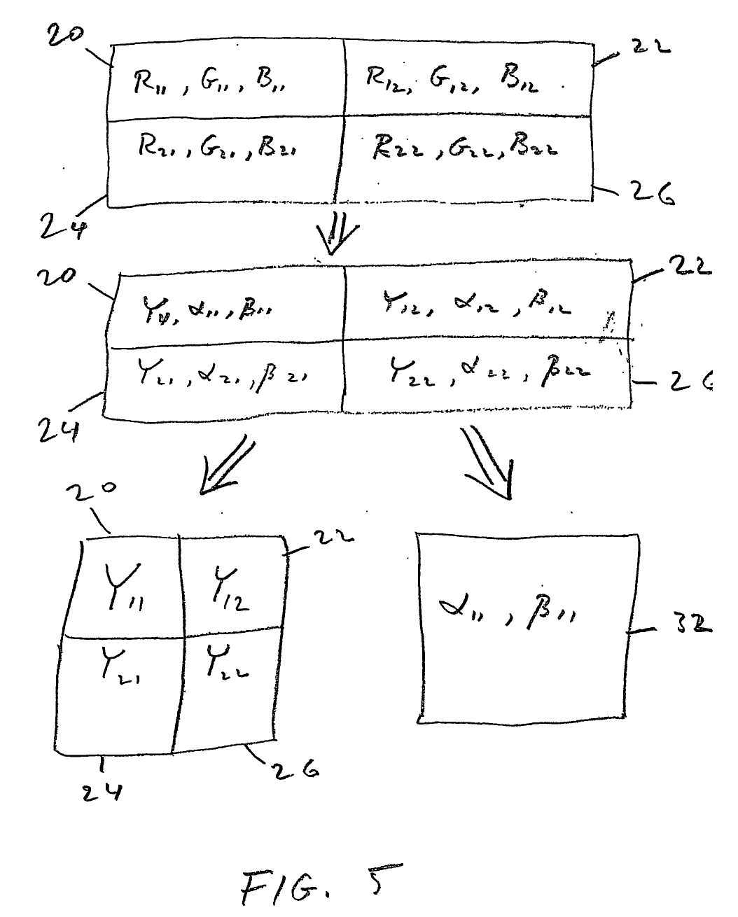

I have found that transforming an image of RGB pixels to Yαβ space, downsampling the resulting Yαβ coordinate values with respect to α and β and further truncating the wordlengths of the Y coordinate values and of the downsampled α and β coordinate values provides a compressed image that has almost the same visual quality as the original RGB image but that has only one-third as many bits as the original image. Specifically, starting with a conventional 24-bit (True Color) RGB image, the RGB coordinates of the image pixels are transformed to Yαβ coordinates and downsampled 4:1:1, as illustrated in FIG. 5. Then the wordlengths of the Y-coordinate values are truncated from eight bits to five bits and the wordlengths of the downsampled α and β coordinate values are truncated from eight bits to six bits. The overall compression is from 24 bits (three times the True Color RGB wordlength) per image pixel to 8 bits (equal to the True Color RGB wordlength) per pixel.

FIG. 5 shows all four image pixels 20, 22, 24 and 26 being merged with respect to their angular coordinates to give a single downsampled pixel 32 that retains only the angular coordinate values of image pixel 20. Alternatively, the angular coordinates of image pixel 20 could be the angular coordinates of any of the other image pixels 22, 24 or 26, or an average of all four sets of angular coordinates.

Although the primary intended application of the present invention is to the compression of RGB images, the principles of the present invention are applicable to images whose pixels are encoded using other color spaces, for example the HSL (Hue, Saturation, Luminance) color space.

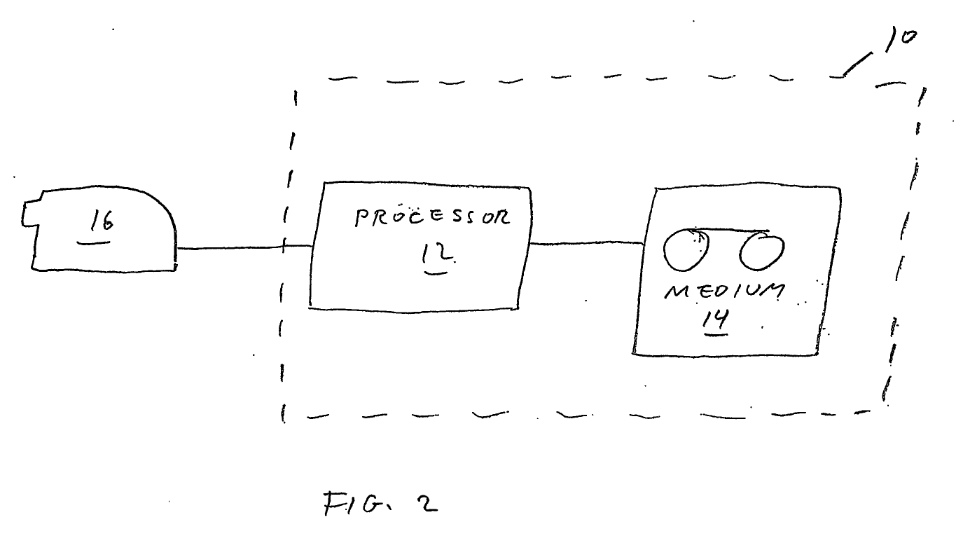

FIG. 2 is a high-level block diagram of an image compression device 10 of the present invention. Device 10 includes a processor 12 and a digital storage medium 14 such as a digital video tape or a nonvolatile memory (e.g. a compact disk or a flash disk). Processor 12 receives a stream of digital RGB video images from a vide camera 16, compresses the images using the method of the present invention, and stores the compressed images, as one truncated-wordlength value of Y per original image pixel and one truncated-wordlength value of each angular coordinate α and β per downsampled pixel, on medium 14.

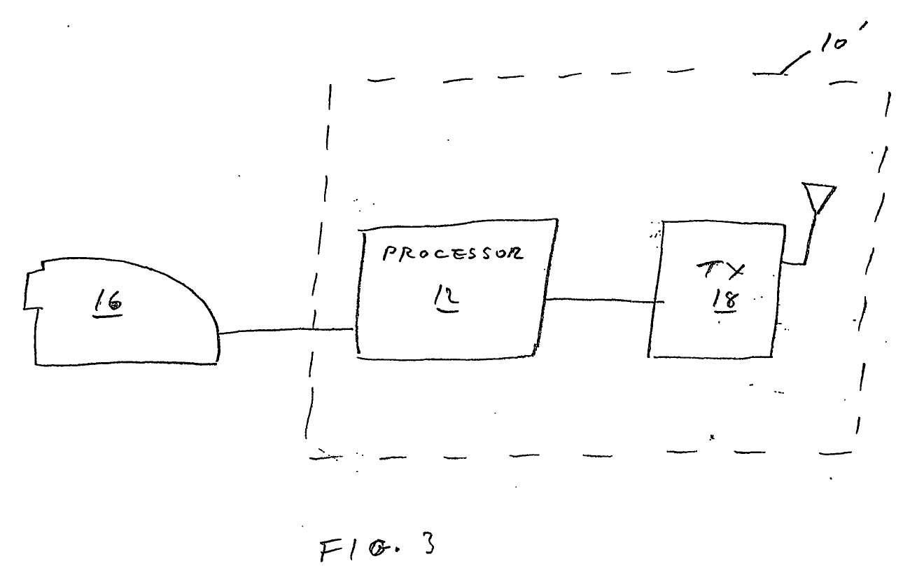

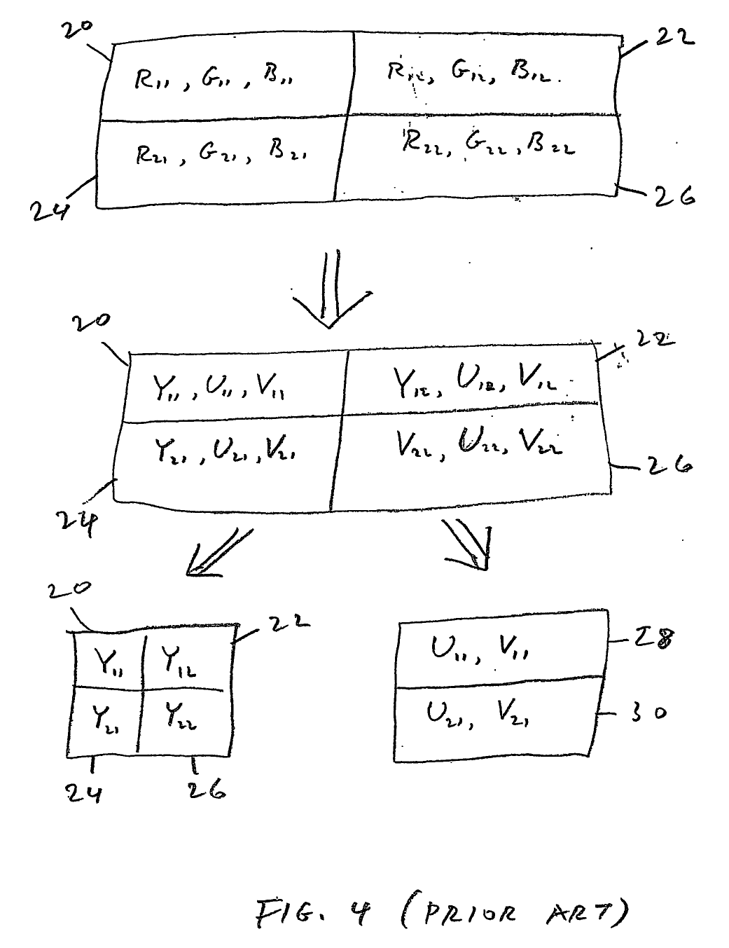

FIG. 3 is a high-level block diagram of another image compression device 10′ of the present invention. Device 10′ includes processor 12 and, in place of medium 14, a transmitter 18. Processor 12 receives a stream of digital RGB video data from video camera 16, compresses the images using the method of the present invention, and uses transmitter 18 to transmit the compressed images, as one truncated-wordlength value of Y per original image pixel and one truncated-wordlength value of each angular coordinate α and β per downsampled pixel, to a remote receiver.

In one preferred embodiment of the present invention, processor 12 is an appropriately programmed general-purpose processor. In an alternate preferred embodiment of the present invention, processor 12 is a special-purpose processor that uses dedicated hardware to implement the method of the present invention.

While the invention has been described with respect to a limited number of embodiments, it will be appreciated that many variations, modifications and other applications of the invention may be made.

What is claimed is:

1. A method of encoding a color, comprising the steps of:
(a) defining the color as a triplet of Cartesian color space coordinate values; and
(b) transforming said triplet to spherical coordinates.

2. The method of claim 1, wherein said color space is an RGB color space.

3. The method of claim 2, wherein said spherical coordinates include an azimuth coordinate in an RG plane.

4. The method of claim 2, wherein said spherical coordinates include an azimuth coordinate in an RB plane.

5. The method of claim 2, wherein said spherical coordinates include an azimuth coordinate in a GB plane.

6. The method of claim 1, wherein said triplet has a color space coordinate wordlength, and wherein said transforming produces a transformed triplet of spherical coordinate values, the method further comprising the step of:
(c) truncating a wordlength of at least one of said spherical coordinate values to at a lower wordlength than said color space coordinate wordlength.

7. A method of compressing an image that includes a plurality of image pixels, each image pixel including a respective triplet, of Cartesian color space coordinate values, all said coordinate values having a common color space coordinate wordlength, the method comprising the steps of:
(a) transforming said each triplet to spherical coordinates, thereby providing a respective transformed triplet of spherical coordinate values; and
(b) spatially downsampling said image pixels with respect to at least one of said spherical coordinates; thereby producing, for each said at least one spherical coordinate, a plurality of downsampled pixels.

8. The method of claim 7, wherein said color space is an RGB color space.

9. The method of claim 8, wherein said spherical coordinates include an azimuth coordinate in an RG plane.

10. The method of claim 8, wherein said spherical coordinates include an azimuth coordinate in an RB plane.

11. The method of claim 8, wherein said spherical coordinates include an azimuth coordinate in a GB plane.

12. The method of claim 7, wherein said spherical coordinates include an azimuth coordinate and an elevation coordinate, and wherein said spatial downsampling is effected with respect to both said azimuth coordinate and said elevation coordinate.

13. The method of claim 8, further comprising the step of:
(c) for at least one of said spherical coordinates, truncating a wordlength of said spherical coordinate values to a lower wordlength than said color space coordinate wordlength.

14. The method of claim 12, wherein said spatial downsampling and said truncating together produce an average number of bits per input pixel that is less than twice the color space coordinate wordlength.

15. The method of claim 14, wherein said average number of bits per input pixel is at most the color space coordinate wordlength.

16. A color image compression device, for compressing an image that includes a plurality of image pixels, each image pixel including a respective triplet, of Cartesian color space coordinate values, that has a color space coordinate wordlength, the device comprising:
(a) a processor for:
(i) transforming each triplet to spherical coordinates, thereby providing a respective transformed triplet of spherical coordinate values, and
(ii) spatially downsampling said image pixels with respect to at least one of said spherical coordinates, thereby producing, for each said at least one spherical coordinate, a plurality of downsampled pixels.

17. The device of claim 16, further comprising:
(b) a medium for storing said downsampled pixels.

18. The device of claim 8, further comprising:
(b) a transmitter for transmitting said downsampled pixels.

19. The device of claim 16, wherein, for at least one of said spherical coordinates, said processor also truncates a wordlength of said spherical coordinate values to a lower wordlength than said color space coordinate wordlength.
